(19) United States
(12) Patent Application Publication
(10) Pub. No.: US 2015/0316673 A1
(43) Pub. Date: Nov. 5, 2015

(54) Systems and Methods for 3D Seismic Data Depth Conversion Utilizing Artificial Neural Networks

(71) Applicants: Jacky M. WIENER, (US); Michael John EBERHARD, (US); Stewart Arthur LEVIN, (US); LANDMARK GRAPHICS CORPORATION, Houston, TX (US)

(72) Inventors: Jacky Muri Wiener, Aurora, CO (US); Michael John Eberhard, Thornton, CO (US); Stewart Arthur Levin, Menlo Park, CA (US)

(21) Appl. No.: 14/646,836

(22) PCT Filed: Dec. 5, 2012
(86) PCT No.: PCT/US12/67989

§ 371 Date: May 22, 2015

(51) Int. Cl. G01V 1/32; G06N 3/08; G01V 1/28

(52) U.S. Cl. CPC G01V 1/32; G01V 1/282; G06N 3/08; G01V 2210/48

(57) ABSTRACT

Systems and methods for the conversion of stacked, or preferably, time migrated 3D seismic data and associated seismic attributes from a time domain to a depth domain.

### CROSS-REFERENCE TO RELATED APPLICATIONS

Not applicable.

### STATEMENT REGARDING FEDERALLY SPONSORED RESEARCH

Not applicable.

### FIELD OF THE INVENTION

The present invention generally relates to systems and methods for three-dimensional (“3D”) seismic data depth conversion utilizing artificial neural networks. More particularly, the present invention relates to the conversion of stacked or, preferably, time migrated 3D seismic data and associated seismic attributes from a time domain to a depth domain.

### BACKGROUND OF THE INVENTION

Converting 3D seismic data from a time domain to a depth domain is critically important for geoscientists and reservoir engineers involved in estimating reservoir reserves through reservoir characterization studies, horizontal well planning and geo-steering, stimulation design and reservoir simulation. Depth converted seismic data may be used to enhance stratigraphic mapping of reservoir porosity and thickness with well control, prove the structural/fault interpretation along the length of horizontal wells in order to stay in the hydrocarbon zone, to provide a more accurate framework for reservoir reserve calculations and overall asset management.

Many conventional techniques and procedures have been developed to convert seismic data from a time domain to a depth domain. These techniques include developing velocity models from check-shot surveys, velocity surveys, stacking velocities, tomography, acoustic inversion, well log data, and the like. Many of these techniques, however, are focused on the conversion of a reservoir horizon (structural mapping) from a time domain to a depth domain instead of converting a seismic volume and its associated seismic attributes from a time domain to a depth domain, which is commonly referred to as volume depthing. Moreover, the volume depthing currently practiced is never 100% accurate for use in reservoir characterization studies because the velocity model ends up being too simple for the resolution required. As a consequence, the reservoir interval of interest is smoothed or even lost in the result when the entire seismic volume is converted to a depth domain.

Modern seismic interpretation methods and tools routinely employ co-rendering of various seismic attributes alongside or overlaying the seismic volumes. Most of the hundred-plus attributes that are employed for seismic interpretation are both computed and interpreted in a time domain. Converting them to depth in tandem with depth conversion of the seismic data is generally feasible, but rarely done in practice. Furthermore, such attribute depth conversions suffer from the same losses of resolution in reservoir intervals noted above as the seismic depth conversion does. Indeed, due to the higher sharpness of many time-based attributes, the damage can be even more severe. Significant recent research has focused on horizon-based attributes such as coherence and curvature that can be computed either in a time or depth domain. Such attributes provide value in a depth domain, but are rarely interpreted, or even interpretable, as volume attributes in the depth domain. Clearly a high resolution method for mapping the many time domain reservoir attributes to a depth domain would be desirable to aid in improving the reliability and detail of seismic interpretation and subsequent reservoir evaluation and planning.

### SUMMARY OF THE INVENTION

The present invention meets the above needs and overcomes one or more deficiencies in the prior art by providing systems and methods for the conversion of stacked, or preferably, time migrated 3D seismic data and associated seismic attributes from a time domain to a depth domain.

In one embodiment, the present invention includes a method for converting three-dimensional seismic data from a time domain to a depth domain, which comprises i) predicting interval transit times for selected wells without sonic logs within or near a reservoir interval of interest using an artificial neural network; ii) converting time-depth pairs for the selected wells to time-depth pairs along a seismic time horizon; iii) forming a reference horizon by realigning seismic traces in a three-dimensional seismic time volume to align the seismic time horizon with a time zero on each trace; iv) assigning a relative depth to each seismic sample value and respective seismic attribute value at or near the reservoir interval of interest using the converted time-depth pairs; v) forming multiple structurally correct surfaces representing a time-depth horizon volume; and vi) transferring each seismic sample value and respective seismic attribute value at or near the reservoir interval of interest from the seismic time volume to the multiple structurally correct surfaces in the time-depth horizon volume.

In another embodiment, the present invention includes a program carrier device for carrying computer executable instructions for converting three-dimensional seismic data from a time domain to a depth domain. The instructions are executable to implement i) predicting interval transit times for selected wells without sonic logs within or near a reservoir interval of interest using an artificial neural network; ii) converting time-depth pairs for the selected wells to time-depth pairs along a seismic time horizon; iii) forming a reference horizon by realigning seismic traces in a three-dimensional seismic time volume to align the seismic time horizon with a time zero on each trace; iv) assigning a relative depth to each seismic sample value and respective seismic attribute value at or near the reservoir interval of interest using the converted time-depth pairs; v) forming multiple structurally correct surfaces representing a time-depth horizon volume; and vi) transferring each seismic sample value and respective seismic attribute value at or near the reservoir interval of interest from the seismic time volume to the multiple structurally correct surfaces in the time-depth horizon volume.

Additional aspects, advantages and embodiments of the invention will become apparent to those skilled in the art from the following description of the various embodiments and related drawings.

### BRIEF DESCRIPTION OF THE DRAWINGS

The present invention will be described with reference to the accompanying drawings in which like elements are referenced with like reference numerals, and in which:

FIG. 1 is a flow diagram illustrating one embodiment of a method for implementing the present invention.

FIG. 2 is a block diagram illustrating one embodiment of a system for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present invention are not limited thereto and may also be applied in other industries, such as water resource management, carbon sequestration, or medical imaging to achieve similar results.

### Method Description

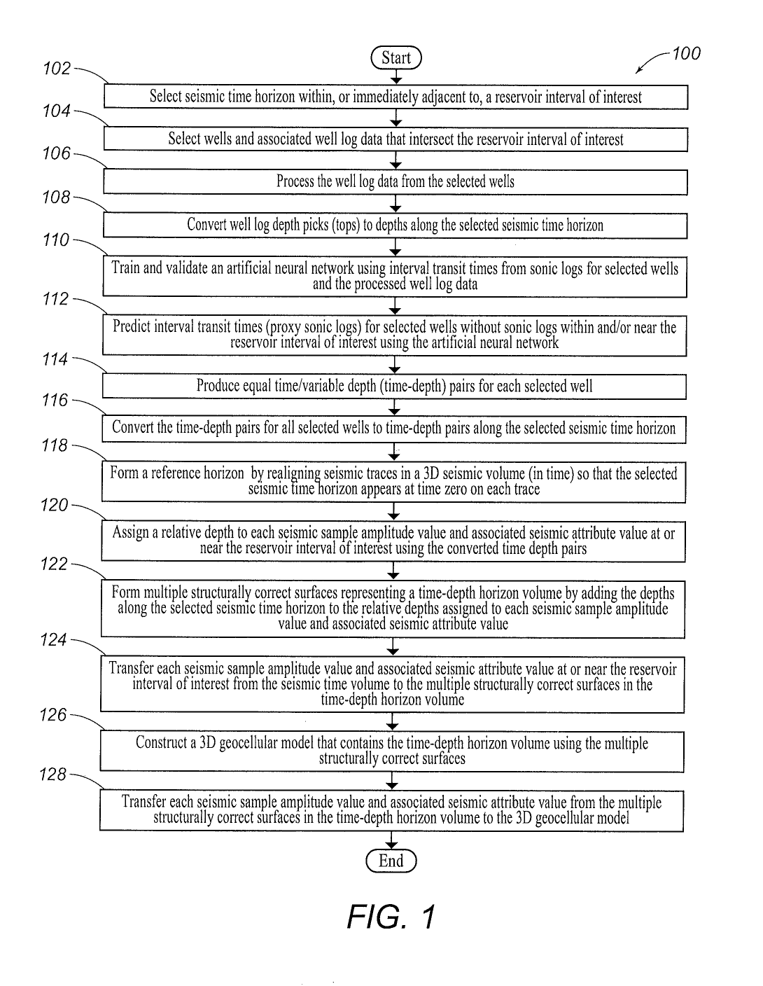

Referring now to FIG. 1, a flow diagram of one embodiment of a method 100 for implementing the present invention is illustrated. The method 100 provides a very efficient way to easily convert, with high resolution, 3D seismic data and associated seismic attributes from a time domain to a depth domain for use in reservoir studies. In the presence of structural overburden complexity, the time-migrated seismic data may be image-ray corrected using the method of Lamer, et al. (1981). The method 100 incorporates one or more steps for training a multi-perception back-propagation artificial neural network to learn the interval transit times for each well in the reservoir study area. An artificial neural network is used for the purpose of predicting sonic logs from other logs related to the same well for wells where sonic logs are not available or are available but contaminated with unacceptable noise. The artificial neural network may be trained to predict sonic logs using wells that do have good sonic logs. The reasonable underlying assumption is that unknown lateral variations of the artificial neural network coefficients would be insignificant within the specific reservoir interval of interest due to similarity in geology, burial history, etc. and thus, a single artificial neural network can be used for all of the wells. More than one artificial neural network, however, may be preferred.

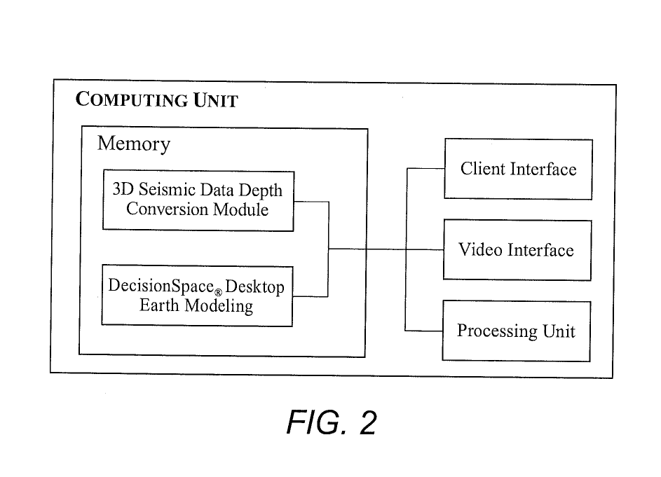

In step 102, a seismic time horizon is selected within, or immediately adjacent to, a reservoir interval of interest using the client interface and/or the video interface described in reference to FIG. 2 and techniques well known in the art. The reservoir interval may be interpreted using the reservoir seismic data in order that the seismic time horizon may be identified and selected within, or immediately adjacent to, the reservoir interval of interest. The seismic time horizon may arise from a reflection from the top or base of the reservoir interval or a reflection from some other layering within, immediately above or immediately below the reservoir interval. Alternatively, a seismic depth horizon may be selected in the same manner with depth-migrated seismic data instead of with time-migrated seismic data when in the presence of structural complexity in both the overburden and reservoir. The seismic depth horizon may be converted to a seismic time horizon using techniques well known in the art such as, for example, ray tracing or eikonal methods, while maintaining the well locations on the seismic time horizon.

In step 104, wells and associated well log data that intersect the reservoir interval of interest may be selected using the client interface and/or the video interface described in reference to FIG. 2.

In step 106, the well log data from the selected wells may be processed using well-known multi-variate statistical techniques to remove unreliable data components, like noise. The well log data may comprise, for example, available data from open hole or cased hole well log data.

In step 108, the well log depth picks (tops) may be converted to depths along the selected seismic time horizon using techniques well known in the art. The depth of the reflecting horizon corresponding to the selected seismic time horizon is identified in the wells and those depth picks may be interpolated and/or extrapolated using techniques such as kriging to provide a depth for every sampled location within the selected seismic time horizon.

In step 110, an artificial neural network may be trained and validated using interval transit times from sonic logs for the selected wells, the processed well log data and techniques well known in the art.

In step 112, interval transit times (proxy sonic logs) for the selected wells without valid sonic logs within and/or near the reservoir interval of interest may be predicted using the artificial neural network. The interval transit times generated by the artificial neural network may be carefully analyzed and studied using well-known quality control techniques to confirm the level of accuracy required for each interval transit time.

In step 114, equal time/variable depth (time-depth) pairs may be produced for each selected well in the reservoir interval of interest by numerically integrating the interval transit times from sonic logs for the selected wells and the interval transit times for the proxy sonic logs. The time origin for the integration is established at the depth of the selected seismic time horizon for each well location. The equal time increment is preferably that of the seismic data being analyzed, often 2 milliseconds, although a finer increment may be chosen and the seismic data resampled to that finer increment to facilitate visualization and interpretation. The variable depth reservoir interval may be as small or as large as necessary. Care is taken to make small adjustments as needed to ensure that the depths are consistent with available geological horizon picks. In this manner, a highly accurate time-depth model may be developed that takes into account both the vertical variation and the lateral variation at an extremely detailed level. By comparison, other conventional techniques may only use as few as one well or one check-shot survey, resulting in an over-simplified, smoothed velocity model producing a time-depth relationship without the necessary detail.

In step 116, the time-depth pairs for all selected wells may be converted to time-depth pairs along the selected seismic time horizon using techniques well-known in the art.

In step 118, a reference horizon is formed by realigning seismic traces in a 3D seismic volume (in time) so that the selected seismic time horizon appears at time zero on each trace. Each individual seismic trace in the seismic time volume is shifted up or down so that the selected seismic time horizon on each trace assumes a new constant time. For example, if on seismic trace (I,J) the reference horizon time is 2.14 seconds and the constant time is 1.96 seconds, then the entire seismic trace would be realigned by shifting upward 0.18 seconds. After each seismic trace (I,J) is processed, the reference horizon will appear as a flat horizon aligned at 1.96 seconds on every seismic trace. At this point the reference horizon is the origin time for all subsequent depthing.

In step 120, a relative depth is assigned to each seismic sample amplitude value and associated seismic attribute value at or near the reservoir interval of interest using the converted time-depth pairs. If for example, the seismic data is sampled at a constant time step (e.g. 2 millisecond increments) and the reference horizon is a 1.996 second horizontal slice, it is followed in time by a 1.998 time slice, a 2.000 second time slice, etc. The subsurface distance between each horizontal slice is generally not a constant depth increment, but will generally vary from trace to trace and time to time. In the case of linear increase of velocity with depth, the depth steps grow exponentially with time. So if the horizon is at 1.996 seconds, the 1.998 second time slice might correspond to a position 6 feet below the reference horizon and the 2.000 second time slice to a position 15 feet below the reference horizon.

In step 122, multiple structurally correct surfaces representing a time-depth horizon volume may be formed by adding the depths along the selected seismic time horizon to the depths assigned to each seismic sample amplitude value and associated seismic attribute value. In this manner, an absolute depth for each seismic sample amplitude value and associated seismic attribute value at and/or near the reservoir interval of interest may be determined. Each depth corresponds to a time-depth pair along the selected seismic time horizon and defines a structurally correct surface in depth. The collection of the multiple structurally correct surfaces define a time-depth horizon volume and bound a depth volume within the subsurface.

In step 124, each seismic sample amplitude value and associated seismic attribute value at or near the reservoir interval of interest may be transferred from the seismic time volume to the multiple structurally correct surfaces in the time-depth horizon volume using techniques well-known in the art such as, for example, arithmetic (mean, closest to node, median, average, etc.) methods, geometric methods, or geostatistical methods. In this manner, the seismic time volume and the time-depth horizon volume are colocated. Preferably, the seismic attributes are transferred from the seismic time volume to the multiple structurally correct surfaces in the time-depth horizon volume using the value closest to the horizon sample location as it appears to be statistically the most accurate. Additionally, when the selected seismic time horizon has significant structural complexity prior to realigning, it is preferable to recompute seismic attributes in a direction most perpendicular to that surface as described in U.S. Pat. No. 7,702,463 prior to transferring them to the multiple structurally correct surfaces.

In step 126, a 3D geocellular model may be constructed that contains the time-depth horizon volume using the multiple structurally correct surfaces and techniques well-known in the art such as those embodied in commercial software packages such as Landmark Graphics Corporation's DecisionSpace® Desktop.

In step 128, each seismic sample amplitude value and associated seismic attribute value from the structurally correct surfaces in the time-depth horizon volume may be transferred to the 3D geocellular model using techniques well known in the art. Because each seismic attribute value is in the depth domain and perfectly collocated with the reservoir well interval, engineering data and micro-seismic information, the 3D geocellular model may be used in reservoir and/or other oil and gas characterization studies as well as horizontal well planning in unconventional reservoirs. Additional benefits may include, for example, use of the results for designing well stimulation, micro-seismic detection (fault detection) and wireline logging.

### System Description

The present invention may be implemented through a computer-executable program of instructions, such as program modules, generally referred to software applications or application programs executed by a computer. The software may include, for example, routines, programs, objects, components and data structures that perform particular tasks or implement particular abstract data types. The software forms an interface to allow a computer to react according to a source of input. DecisionSpace® Desktop Earth Modeling, which is a commercial software application marketed by Landmark Graphics Corporation, may be used as an interface application to implement the present invention. The software may also cooperate with other code segments to initiate a variety of tasks in response to data received in conjunction with the source of the received data. Other code segments may provide optimization components including, but not limited to, neural networks, earth modeling, history matching, optimization, visualization, data management, reservoir simulation and economics. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire, and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

Referring now to FIG. 2, a block diagram illustrates one embodiment of a system for implementing the present invention on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the invention.

The memory primarily stores the application programs, which may also be described as program modules containing computer-executable instructions, executed by the computing unit for implementing the present invention described herein and illustrated in FIG. 1. The memory therefore, includes a 3D seismic data depth conversion module, which enables the methods illustrated and described in reference to FIG. 1 and integrates functionality from the remaining application programs illustrated in FIG. 2. The memory also includes DecisionSpace® Desktop Earth Modeling, which may be used as an interface application to supply well log input data to the 3D seismic data depth conversion module and/or display the data results from the 3D seismic data depth conversion module. Although DecisionSpace® Desktop Earth Modeling may be used as an interface application, other interface applications may be used, instead, or the 3D seismic data depth conversion module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well-known.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for converting three-dimensional seismic data from a time domain to a depth domain, which comprises:
predicting interval transit times for selected wells without sonic logs within or near a reservoir interval of interest using an artificial neural network;
converting time-depth pairs for the selected wells to time-depth pairs along a seismic time horizon;
forming a reference horizon by realigning seismic traces in a three-dimensional seismic time volume to align the seismic time horizon with a time zero on each trace;
assigning a relative depth to each seismic sample value and respective seismic attribute value at or near the reservoir interval of interest using the converted time-depth pairs;
forming multiple structurally correct surfaces representing a time-depth horizon volume; and
transferring each seismic sample value and respective seismic attribute value at or near the reservoir interval of interest from the seismic time volume to the multiple structurally correct surfaces in the time-depth horizon volume.

2. The method of claim 1, wherein the artificial neural network is trained using interval transit times from sonic logs for the selected wells.

3. The method of claim 1, wherein the seismic time horizon is selected within the reservoir interval of interest.

4. The method of claim 1, wherein the selected wells intersect the reservoir interval of interest.

5. The method of claim 1, wherein the multiple structurally correct surfaces representing the time-depth horizon volume are formed by adding depths along the seismic time horizon to the relative depths assigned to each seismic sample value and respective seismic attribute value.

6. The method of claim 5, wherein the depths along the seismic time horizon are converted from well log depth picks for the selected wells.

7. The method of claim 1, further comprising constructing a three-dimensional geocellular model that contains the time-depth horizon volume using the multiple structurally correct surfaces.

8. The method of claim 1, further comprising transferring each seismic sample value and respective seismic attribute value from the multiple structurally correct surfaces in the time-depth horizon volume to the three-dimensional geocellular model.

9. The method of claim 2, wherein the time-depth pairs for the selected wells are produced for each selected well in the reservoir interval of interest by numerically integrating the interval transit times and the predicted interval transit times.

10. The method of claim 5, wherein the addition of the depths along the seismic time horizon and the relative depths assigned to each seismic sample value and respective seismic attribute value represent an absolute depth for each seismic sample value and respective seismic attribute value, and define a structurally correct surface at each absolute depth.

11. The method of claim 1, wherein the seismic time horizon is obtained by converting a seismic depth horizon to the seismic time horizon.

12. A program carrier device for carrying computer executable instructions for converting three-dimensional seismic data from a time domain to a depth domain, the instructions being executable to implement:
predicting interval transit times for selected wells without sonic logs within or near a reservoir interval of interest using an artificial neural network;
converting time-depth pairs for the selected wells to time-depth pairs along a seismic time horizon;
forming a reference horizon by realigning seismic traces in a three-dimensional seismic time volume to align the seismic time horizon with a time zero on each trace;
assigning a relative depth to each seismic sample value and respective seismic attribute value at or near the reservoir interval of interest using the converted time-depth pairs;
forming multiple structurally correct surfaces representing a time-depth horizon volume; and
transferring each seismic sample value and respective seismic attribute value at or near the reservoir interval of interest from the seismic time volume to the multiple structurally correct surfaces in the time-depth horizon volume.

13. The program carrier device of claim 12, wherein the artificial neural network is trained using interval transit times from sonic logs for the selected wells.

14. The program carrier device of claim 12, wherein the seismic time horizon is selected within the reservoir interval of interest.

15. The program carrier device of claim 12, wherein the selected wells intersect the reservoir interval of interest.

16. The program carrier device of claim 12, wherein the multiple structurally correct surfaces representing the time-depth horizon volume are formed by adding depths along the seismic time horizon to the relative depths assigned to each seismic sample value and respective seismic attribute value.

17. The program carrier device of claim 16, wherein the depths along the seismic time horizon are converted from well log depth picks for the selected wells.

18. The program carrier device of claim 12, further comprising constructing a three-dimensional geocellular model that contains the time-depth horizon volume using the multiple structurally correct surfaces.

19. The program carrier device of claim 12, further comprising transferring each seismic sample value and respective seismic attribute value from the multiple structurally correct surfaces in the time-depth horizon volume to the three-dimensional geocellular model.

20. The program carrier device of claim 13, wherein the time-depth pairs for the selected wells are produced for each selected well in the reservoir interval of interest by numerically integrating the interval transit times and the predicted interval transit times.

21. The program carrier device of claim 16, wherein the addition of the depths along the seismic time horizon and the relative depths assigned to each seismic sample value and respective seismic attribute value represent an absolute depth for each seismic sample value and respective seismic attribute value, and define a structurally correct surface at each absolute depth.

22. The program carrier device of claim 12, wherein the seismic time horizon is obtained by converting a seismic depth horizon to the seismic time horizon.
